(19) United States
(12) Patent Application Publication
(10) Pub. No.: US 2019/0036421 A1
(43) Pub. Date: Jan. 31, 2019

(54) CLOSED-LOOP FLUIDIC POWER GENERATOR

(71) Applicant: Darin Bain, Spokane, WA (US)

(72) Inventor: Darin Bain, Spokane, WA (US)

(21) Appl. No.: 15/661,629

(22) Filed: Jul. 27, 2017

(51) Int. Cl. H02K 7/18

(52) U.S. Cl. CPC H02K 7/1823; F03B 17/005; Y10S 415/916

(57) ABSTRACT

A closed-loop fluidic power generator system includes a closed-loop tunnel that encloses a power fan producing a primary fluidic stream. The primary fluidic stream is directed through the tunnel and impacts a plurality of fluidic power generators, causing impellers on each fluidic power generator to turn and operate an associated generator and produce electrical power. The electrical power is then delivered to an appropriate load, such as a utility power grid, a dedicated user, such as an industrial complex, or any load, equipment or system requiring electricity. A portion of the primary fluidic stream transits the tunnel and arrives at the input side of the power fan, which continues to operate to make up losses in the primary stream. The power fan is initially started by a battery, which is disconnected once the power fan is running and generating the fluidic stream for generating power.

### COPYRIGHT NOTICE

This disclosure is protected under United States and International Copyright Laws. © 2017 DARIN BAIN All Rights Reserved. A portion of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever.

### FIELD OF THE INVENTION

The present invention relates generally to power generation and more particularly to closed-loop power generation.

### BACKGROUND OF THE INVENTION

Large-scale electrical power generation has typically involved power plants operating on coal, steam, hydro (water) or nuclear fuel. More recently, alternative forms of large-scale power generation have included wind and solar farms. These power plants and farms require a tremendous amount of surface land, pose environmental concerns and are subject to adverse environmental conditions. For example, hydro power plants require dams to, in part, create a reservoir that compensates for changing water flow in rivers. The dams and resulting reservoirs significantly alter the upstream environment. Similarly, wind farms must be located in areas where sufficient wind is present on a regular or constant basis. Likewise, solar farms need to be located where adequate sunlight is available to the solar panels. Nuclear plants are usually located near large water supplies to ensure proper and safe operation. Any change to the environment can have a significant impact on the operation of the power plant/farm.

In addition to being impacted by environmental conditions, typical power plants and farms have a significant impact on the environment, influencing the local ecology and limiting access to the area as well as altering the visual appearance of the area.

Accordingly, there is a need for an apparatus, system and method for generating power that is not impacted by environmental conditions and is less impactful on the local environment.

### SUMMARY OF THE INVENTION

In accordance with a preferred embodiment of the present invention, a closed-loop fluidic power generator comprises an enclosure having a first end and an opposite second end, a fluidic power supply located at least partially inside the tunnel for producing a fluidic stream and, a fluidic power generator located at least partially inside the enclosure in downstream communication with the fluidic power supply, the fluidic power generator generating power from the fluidic stream.

In accordance with an alternative embodiment, a closed-loop fluidic power generating system comprises a closed-loop enclosure defining an internal volume, a fluidic power supply located at least partially inside the closed-loop enclosure for producing a first fluidic stream within the internal volume, and a plurality of fluidic power generators located at least partially inside the enclosure in downstream communication with the fluidic power supply and generating power from the first fluidic stream, and the plurality of fluidic power generators producing a second fluidic stream.

According to yet a further embodiment of the present invention, a method for generating power comprises the steps of producing a first fluidic stream within a closed-loop enclosure, applying the first fluidic stream to a generator and generating power from the first fluidic stream, and using power from the first fluidic stream to generate the first fluidic stream.

### BRIEF DESCRIPTION OF THE DRAWINGS

Preferred and alternative examples of the present invention are described in detail below with reference to the following drawings:

FIG. 1 is a schematic diagram of closed-loop fluidic power generating apparatus, system and method according to a preferred embodiment of the present invention;

FIG. 2 is a sectional view of a portion of the preferred embodiment of FIG. 1;

FIG. 3 is a plan view illustrating a portion of an alternative embodiment of the present invention;

FIG. 4 is a sectional view depicting a portion of the embodiment of FIG. 3;

FIG. 5 is a plan view of a portion of the embodiment of FIG. 3;

FIG. 6 is a schematic representation of a flow straightener in accordance with the embodiment of FIG. 3;

FIG. 7 is a schematic representation of multiple flow straighteners in accordance with the embodiment of FIG. 3;

FIG. 8 is a partial sectional view of elements according to yet a further alternative embodiment of the present invention;

FIG. 9 is plan view of a portion of yet another alternative embodiment of the present invention;

FIG. 10 is plan view of a portion of still a further alternative embodiment of the present invention;

FIG. 11 is a partial sectional view of the embodiment of FIG. 10;

FIG. 12 is a partial plan and sectional view of the embodiment of FIG. 10

FIG. 13 is a sectional view of a portion of a further alternative embodiment of the present invention;

FIG. 14 is a sectional view of elements according to yet a further alternative embodiment of the present invention;

FIG. 15 is plan view of an alternative embodiment of the present invention;

FIG. 16 is plan view of yet a further alternative embodiment of the present invention;

FIG. 17 is a sectional view illustrating certain elements according to an alternative embodiment of the present invention;

FIG. 18 is a partial sectional view of the embodiment of FIG. 17; and,

FIG. 19 is a flowchart of a method for generating power in a closed-loop system according to an embodiment of the present invention.

### DETAILED DESCRIPTION OF THE PREFERRED EMBODIMENT

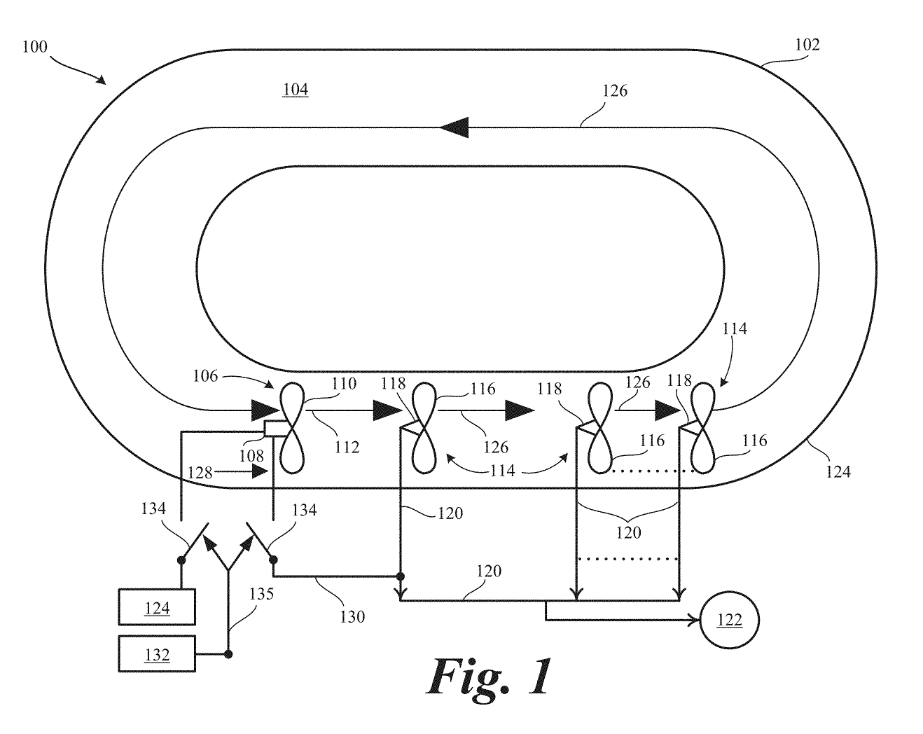

This specification discloses a closed-loop fluidic power generator apparatus and system as well as a method for power generation, collectively referred to herein as a system. FIG. 1 illustrates, in simplified, schematic form, a closed-loop fluidic power generator system 100. System 100 includes an enclosure 102, such as a tunnel that forms a closed-loop environment, having an internal volume 104. A power fan 106 includes a motor 108 and a set of fan blades 110 that, when operating, produce a primary fluidic stream 112, which in accordance with the present embodiment, is air flow, illustrated by a directional arrow indicating the relative direction of flow of fluidic stream 112. The primary fluidic stream 112 is directed through enclosure 102 towards and impacts at least one, and preferably a plurality of, fluidic power generators 114, causing impellors 116 of each fluidic power generator 114 to turn and operate an associated generator unit 118 to produce electrical power 120. The electrical power is then delivered to an appropriate load 122. Load 122 may be, for example, a utility power grid, a dedicated user, such as an industrial complex, or any load, equipment or system requiring electricity.

As a closed-loop system 100, stream 112, or some portion thereof (secondary fluidic stream 126), travels through enclosure 102 and eventually arrives back to an input side 128 of power fan 106. Power fan 106 then operates at a capacity to make up losses to the primary stream 112 resulting from its transit through enclosure 102.

Power fan 106 is initially started by a power source, such as battery 124. Once power fan 106 is running and generating fluidic stream 112, the impellors 116 cause the generators 114 to generate power 120 via generator units 118. The fluidic stream 112 from the power fan 106 impacts generator impellors 116, as well as other structures including the walls of enclosure 102, resulting in secondary fluidic stream 126 which includes losses due, in part, on the design of system 100, including the number of generators, structures and length and shape of enclosure 102. The secondary fluidic stream 126 is directed to the input side 128 of power fan 106 to further aid in the generation of the primary fluidic stream 112 that is output by the power fan 106. A portion 130 of electric power output 120 from a generator unit 118 is tapped to provide input electrical power to operate the power fan 106. The starting and ongoing operation of system 100 is controlled by controller 132 to provide uninterrupted operation. For simplicity, the controller 132 is coupled to switches 134 as illustrated by arrowed line 135. Once the power fan 106 is running, the battery 124 is simultaneously disconnected and the power 130 from the electrical generator unit 118 is connected to the power fan 106 through switches 134. Accordingly, the battery 124 is preferably used only to start the power fan 106 and make it operational. The electrical power output 130 from the generator unit 118 may also be used to recharge batteries 124.

The secondary fluidic stream 126 aids in producing the primary fluidic stream 112 generated by the power fan 106, and as a result, the motor 108 requires less power from the generator unit 118, improving overall efficiency of the system 100.

As will be discussed below, the system 100 may be constructed so as to have minimal impact of the environment and to be minimally impacted by the environment. For example, the enclosure 102 can be constructed underground, and system components, such as the fan 106 and generators 114 may be included in the underground structure. The resulting underground system 100 would have little impact on the surface of the land in the area, e.g., no impact on scenery or accessibility to the surface area around the system 100. Further, since it is an enclosed (closed-loop) system, it is not significantly impacted by weather factors, such as high or low winds, rain or lightening, just to name a few.

As will be further discussed below, system 100 may include any number of generators 114, and these generators 114, along with generator units 118, may be various sizes providing different power outputs 120, and may even provide different forms of electrical power, such as AC and DC. Additionally, the shape of the enclosure 102 may take various forms. As discussed below, the enclosure, which is an overall, closed-loop design, may have different cross sections, such as round or square, and a plan design that could be any closed loop shape, such as, for example, round, oval, pentagon, and irregular to name a few.

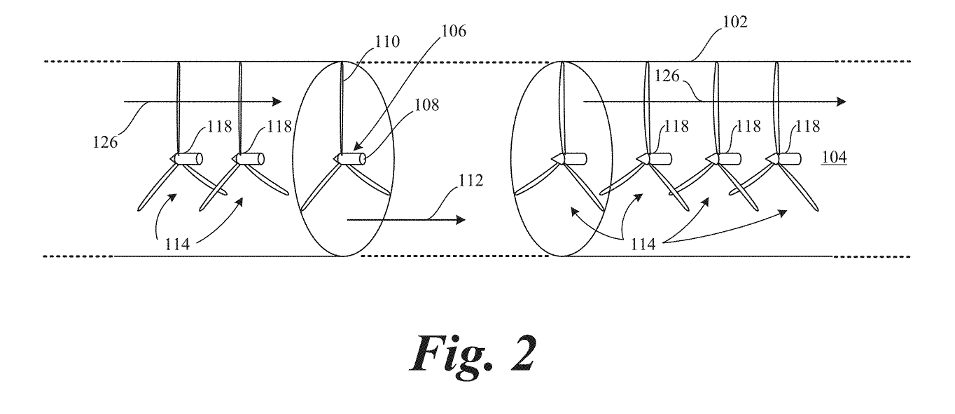

FIG. 2 illustrates a portion of system 100 in which enclosure 102 has a generally circular cross section. It is to be understood, that while only portions of the enclosure 102 is shown, the use of broken lines represents that the enclosure forms a continuous closed loop. Power fan 106 generates primary fluidic stream 112 (flowing from left to right in FIG. 2) and impacts the generators 114. The secondary fluidic stream 126, which includes losses, and thereby has less power (e.g., volume, velocity, etc.) than primary stream 112, transits the enclosure (also from left to right in FIG. 2) and eventually impacts the input side of power fan 106. As mentioned previously, power 130 (FIG. 1) is applied to the motor 108 of fan 106 to allow fan 106 to supplement the secondary stream 126 to continue to produce primary stream 112.

In the example illustrated in FIG. 2, enclosure 102 may, for example, have a six foot internal diameter and the power fan 106 and generators 114 could have a nominal six foot diameter, allowing them to freely spin inside the tunnel of enclosure 102. If, for example, fan 106 requires 1.8 kW for operation, generators 114 could be sized to provide an output of 2 kW each and the 1.8 kW for fan 106 could be supplied from the output 120 of one of the generators 114. Alternatively, power 130 could be provided from more than one generator 114. In this example, primary fluidic stream 112 may travel at a velocity of 30 mph, and assuming a ten percent (10%) loss, the secondary stream 126 arriving at the input side 128 of fan 106 would be less than primary stream 112. The fan 106 boosts the secondary stream 126 to achieve primary stream 112.

Controller (FIG. 1) controls the operation of system 100 and may include necessary control elements as required by the system 100, such as, for example, motor controllers, starters, DC to AC inverters, computers and software. The controller 132, as well other components of system 100, may have wireless capability that allows operators to remotely monitor and control system 100.

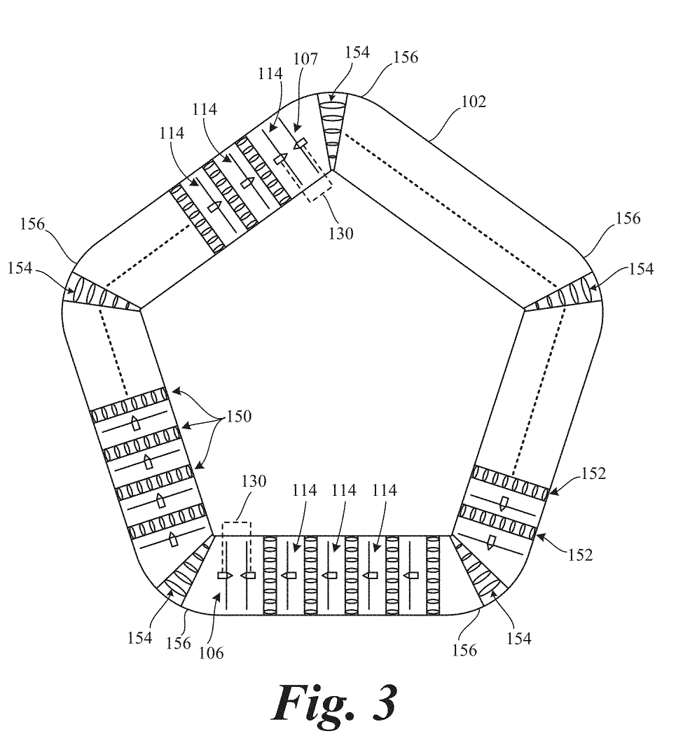

FIG. 3 illustrates a system 100, in which the plan view of the enclosure 102 has a five-sided shape. Once again, the cross section of enclosure 102 is circular and has a nominal six foot internal diameter and, similarly, six foot diameter power fan(s) 106 and generators 114. Vanned supports 150 for the fan 106 and generators 114 reduce or eliminate vortices in the primary and secondary streams 112, 126. Honeycomb flow straighteners 152 placed along the length of enclosure 102 assist in providing uniformity of air flow in the volume 104 of enclosure 102. Vanes 154 located in corner sections 156 of enclosure 102 help in reducing or eliminating pooling of air and assist in providing uniform distribution of air flow in the system 100.

Depending of the size and power specifications of system 100, there may be additional power fan(s) 107. In the system 100 illustrated in FIG. 3, one addition power fan 107 is utilized, however, it is understood that additional units may be used as called for by system 100. The additional power fan 107 may be used to compensate for losses in the system or as a back up to power fan 106. For example, the size and layout of system 100 may be such that the overall system efficiency could be improved by distributing one or more additional power fans 107 throughout the enclosure 102. Additionally, the additional power fan(s) 107 could serve as back up if the power fan 106 failed or required routine maintenance. The secondary power fans 107 would be powered from generators 114 in a fashion similar to that described previously for fan 106. Controller 132 (FIG. 1) provides control to the system 100.

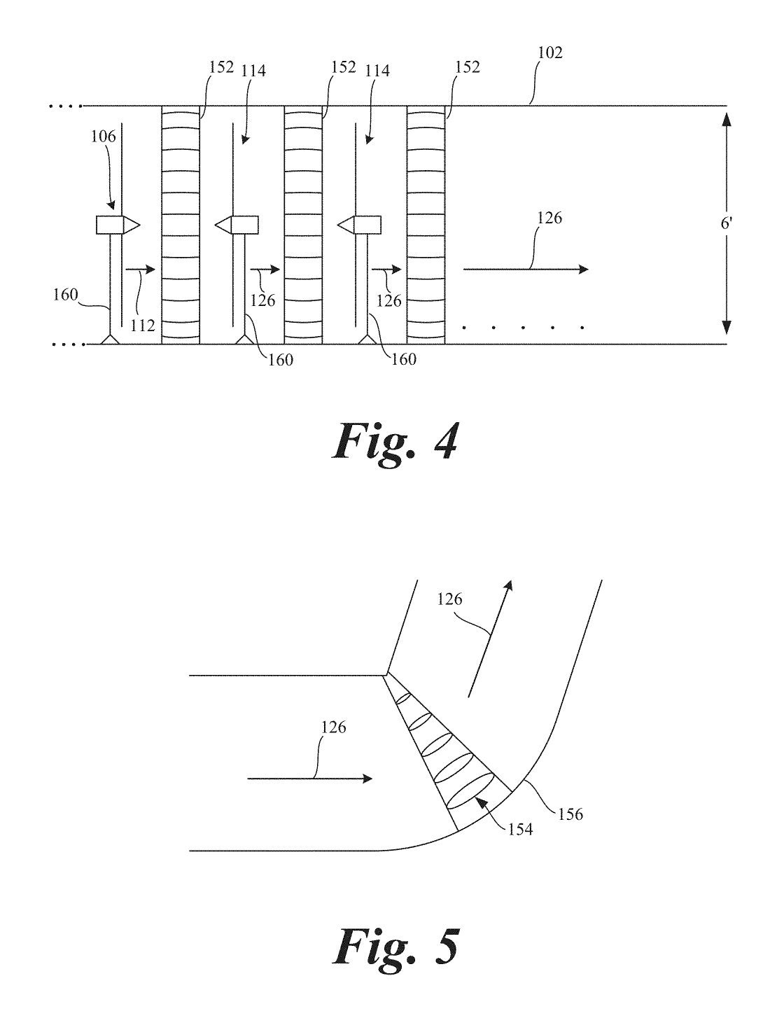

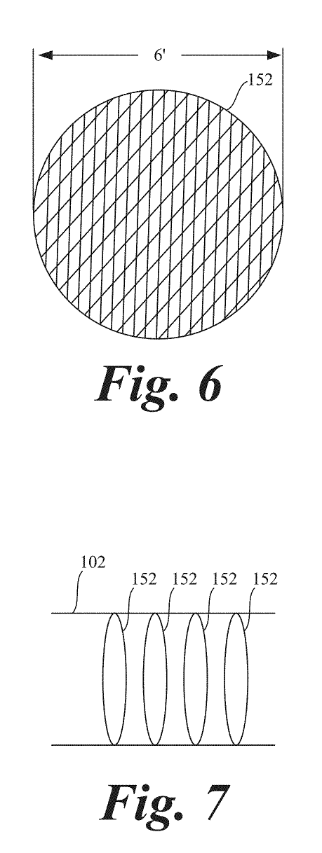

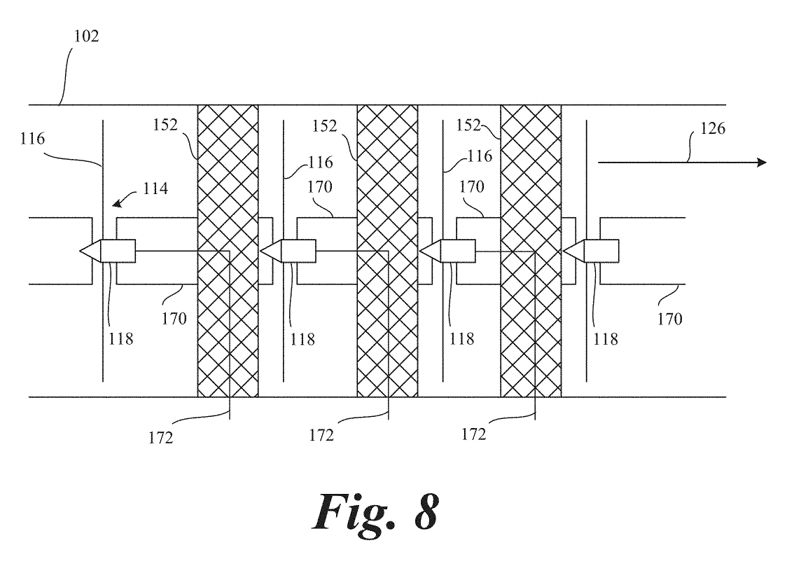

FIG. 4 illustrates, according to one embodiment, the honeycomb flow straighteners 152 positioned inside enclosure 102 and spaced between the fans 106, 107 and generators 114. Mounting structures 160 support the fan(s) 106, 107 and generators 114 and are preferably designed to minimize disruption of streams 112 and 126. Vanes 154 in corner section 156 of housing 102 are further illustrated in FIG. 5. FIG. 6 illustrates a possible configuration for the honeycomb flow straightener 152. The honeycomb flow straightener has a nominal six foot diameter in accordance with the six foot diameter of the housing 102 described above. The honeycomb flow straighteners 152 may be placed in between fans 106, 107 and generators 114 (FIG. 4) or adjacent one another as depicted in simplified form in FIG. 7.

In accordance with another embodiment, an inner tube 170 may be used to support the generators 114. The inner tubes, in turn, may be supported by honeycomb flow straighteners 152. Inner tubes 170 reduce system losses of power in streams 112, 126. For purposes of clarity and simplicity, impellors 116 are shown to be spaced apart from the inner wall of enclosure 102, but it is understood that the spacing is such that proper stream flow and uniformity within the enclosure is achieved. Electrical conduits 172 for delivering power from generator units 118 may be routed through and/or supported by the inner tubes 170 and honeycomb straighteners 152 to further assist in controlling uniformity of stream flow (112, 126).

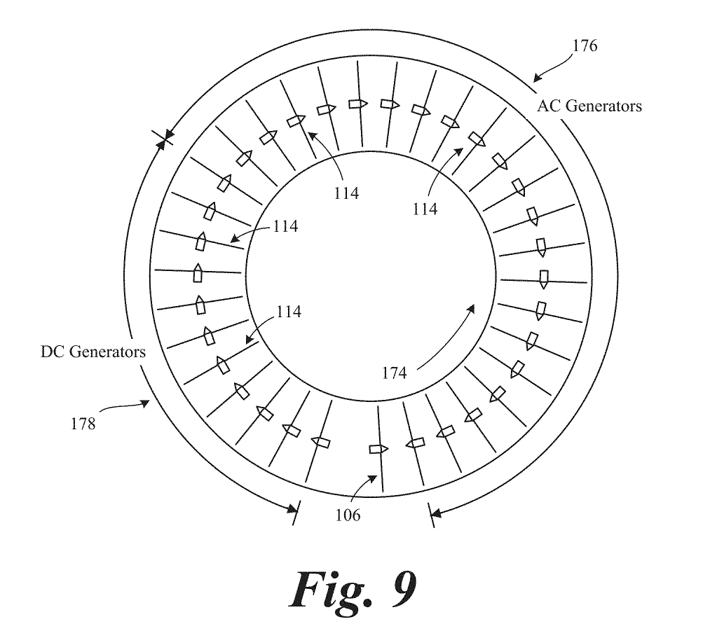

As briefly discussed previously, the electrical power generated by system 100 may be in different forms, such as AC, DC or even both AC and DC. FIG. 9, illustrates a system 100 having a power fan 106 and a plurality of generators 114 arranged in a circular closed-loop housing 102. Stream flows 112 and 126 travel in the counterclockwise direction as indicated by directional arrow 174. Generators 114 are divided into two (2) groups an AC section 176 and a DC section 178, in which the generators 118 in the AC section provide alternating, or AC, power and the generators 118 in the DC section provide direct, or DC, power. The conversion of AC to DC and DC to AC electricity is well known and is not discussed further, but is understood to be provided by the generators 118, or by additional components inside or outside the enclosure 102 and may be monitored and controlled by controller 132 (FIG. 1). The specific power needs supported by system 100 may be met by adjusting the number of AC and DC units as well and the size (power) capabilities of the units (including fan 106 and generators 114).

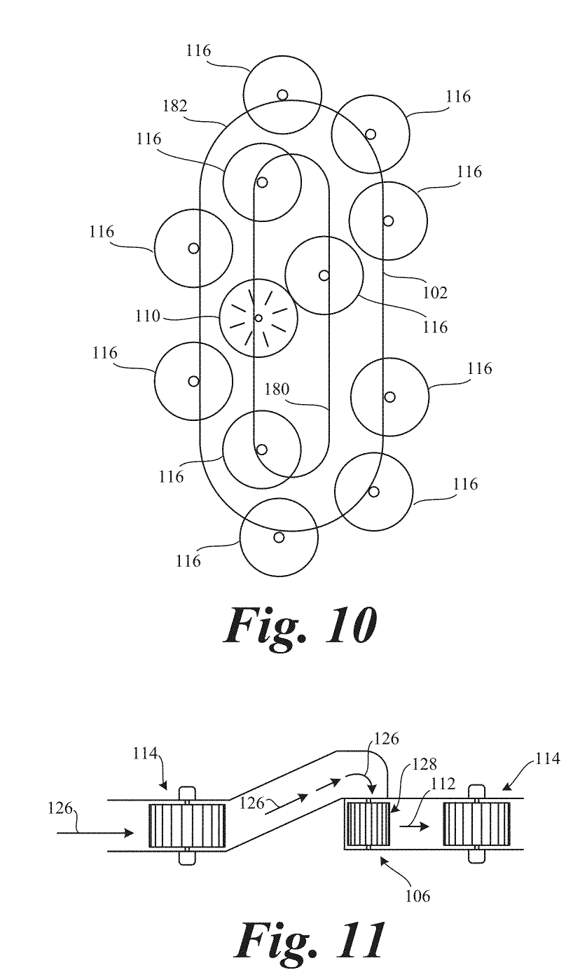

The power fan(s) 106 and generators 114 described above and illustrated in FIGS. 1-9 have been axial-type units. However, in accordance with further embodiments of the present invention, the fan(s) 106 and generators 114 may have other configurations, such a ‘squirrel cage” designs. FIG. 10 illustrates a system 100 having a closed loop housing 102 in which fan 106 and generators 114 are a squirrel-cage design. As depicted in the plan view of FIG. 10, the fan 106 and each generator 114 are arranged so that they reside approximately half inside the enclosure 102 and half outside the enclosure 102. This allows the flow of streams 112, 126 to impact the impellors 116 and cause the generators 114 to generate power. As can be readily understood, the fan(s) and generators 118 may be place along inside wall 180 or outside wall 182 of enclosure 102, or both. With a given direction of stream flow, fan and generators on the outside wall 182 rotate in one direction and the units along the inside wall 180 rotate in the opposite direction. Although not illustrated in FIG. 10, honeycomb flow straighteners 152 and vanes 154 may be used in the system to control uniformity of stream flow throughout the system. The cross section of housing 102 in the system of FIG. 10 is preferably of a square or rectangular shape in cooperation with the squirrel-cage designs of the fan(s) 106 and generators 114.

FIG. 11 illustrates one embodiment for returning stream flow (126) to power fan 106 in a system employing squirrel cage units. In accordance with this embodiment, secondary fluidic stream 126 leaves generator 114 and is directed into the top (input 128) of fan 106, which then discharges primary fluidic stream 112 to generators 114.

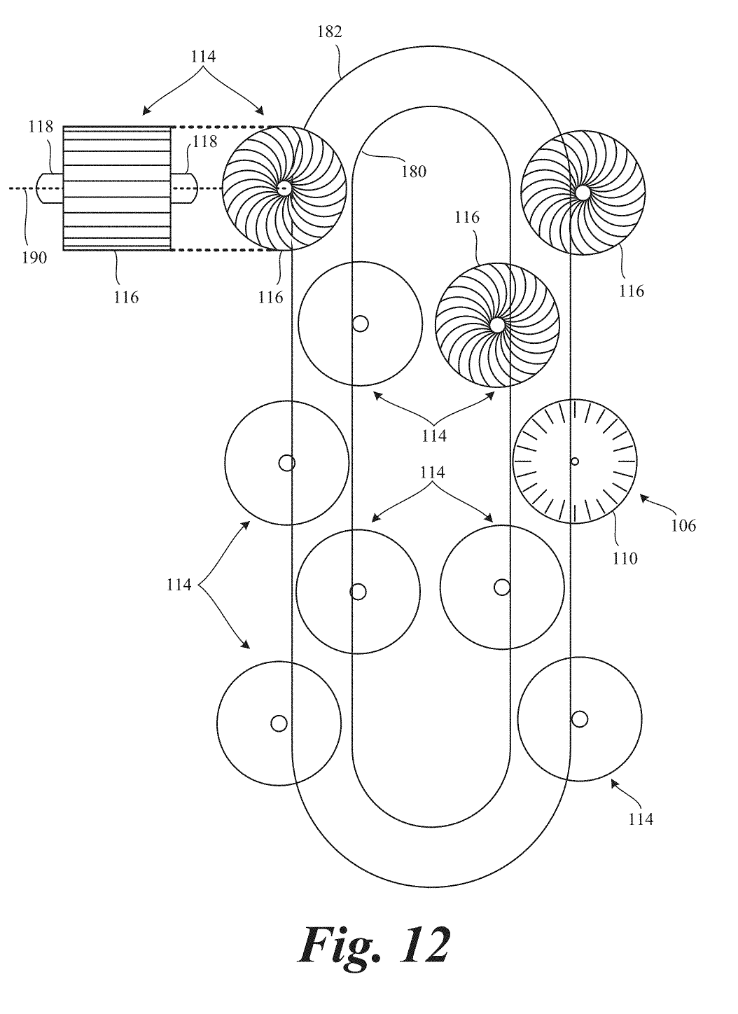

FIG. 12 further illustrates features of the embodiment discussed previously and depicted in FIG. 10. Generators 114 may include one or two generator units 118 coupled to either end of the generator 114, preferably along its rotational axis 190. As depicted in FIG. 12, generator 114 is a squirrel cage unit having impellors 116 that rotate around the unit's axis 190. Mounted on each end of the generator 114 along axis 190 is a pair of generator units 118. Such a configuration may be utilized to increase the power output of system 100.

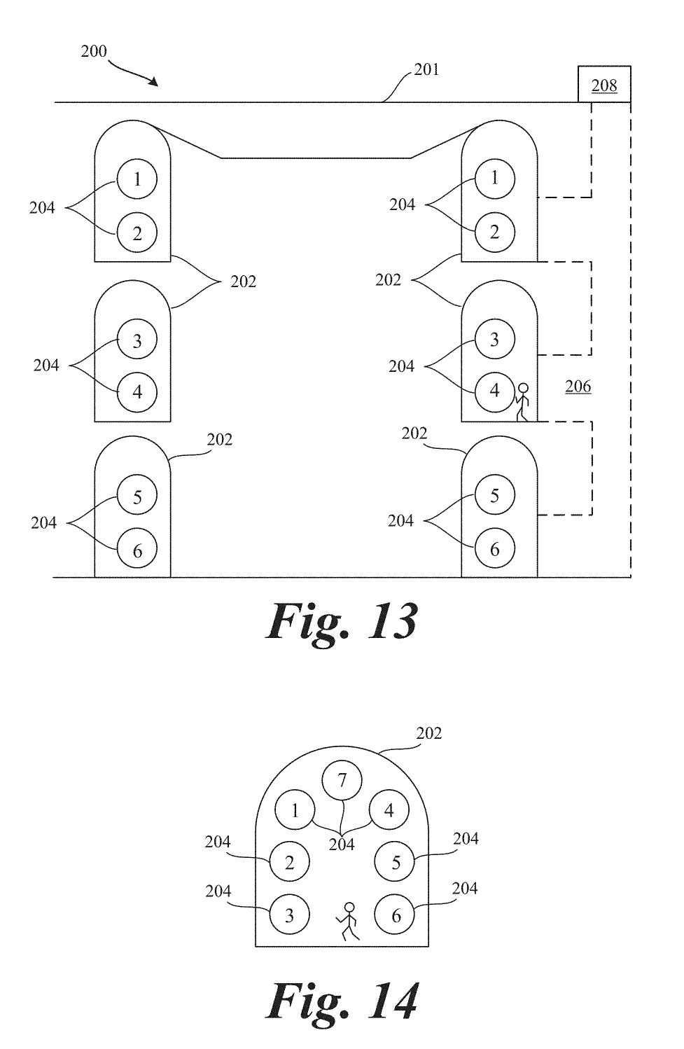

FIGS. 13 and 14 illustrate yet other embodiments of the present invention incorporating a power block design. Turning first to FIG. 13, power block 200 may be installed above, below or partially above and below ground 201. The cross section of power block 200 illustrates three stacked access tunnels 202 incorporating six fluidic stream tunnels 204 (numbered 1-6). For ease of understanding, tunnels 204 are similar to housing 102 discussed above. Power fans 106 and generators 114 (not shown in FIG. 13 for simplicity), reside in or are associated with tunnels 204 and operate in the manner discussed above. Operator access is provided through an entrance 208 to access corridor 206. Access to tunnels 202 and 204 permit access to system 100, for example, for maintenance. Fluidic stream tunnel 204 (#1) may be operated as a back-up system, in which it normally is idle while the other systems in fluid stream tunnels 204 (#2-#6) operate. If one of systems in tunnels 204 (#2-#6) are powered down for maintenance, the system in tunnel 204 (#1) can be started to provide uninterrupted power. The various systems (#1-#6) are preferably monitored and controlled by controller 132 (FIG. 1). FIG. 14 illustrates yet another embodiment of the power block 202 in accordance with the present invention, in which seven (7) fluidic stream tunnels 204 (#1-#7) are located in one access tunnel 202.

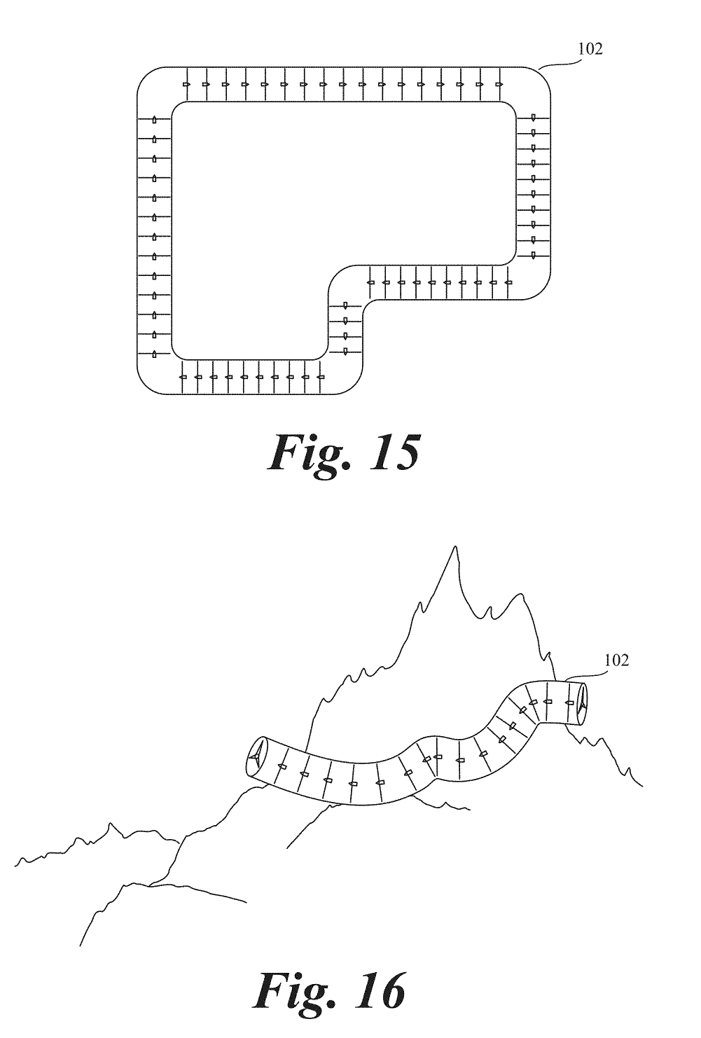

FIGS. 15 and 16 illustrate further embodiments of the present invention depicting examples of overall shapes having different geometries for the closed loop housing 102. FIG. 15 illustrates a plan view of housing 102 suitable, for example, for being built under a building (not shown), such as a hospital, to provide power for the hospital. The concept represented in FIG. 15 would apply to any number of other possibilities, including under a large installation, such as a military base to provide secure AC and DC power to the base.

FIG. 16 illustrates how a closed loop system may be built to conform to the landscape, such as under or within a mountain. Only a portion of the closed-loop system 100 is depicted for simplicity and it is to be understood that the enclosure 102 loops back on itself (not shown) to form a closed loop system 100.

As previously discussed, the fluidic streams 112, 126 of system 100 may be gas or liquid. Air is but one possible gas and has advantages, such as availability. Other suitable gasses include heavier-than-air elements, such as argon and xenon, which offer advantages because of their inherent characteristics, such as resistance to extreme temperatures and combustion. Accordingly, depending on the environment in which system 100 operates, any number of gasses or liquids may be compatible.

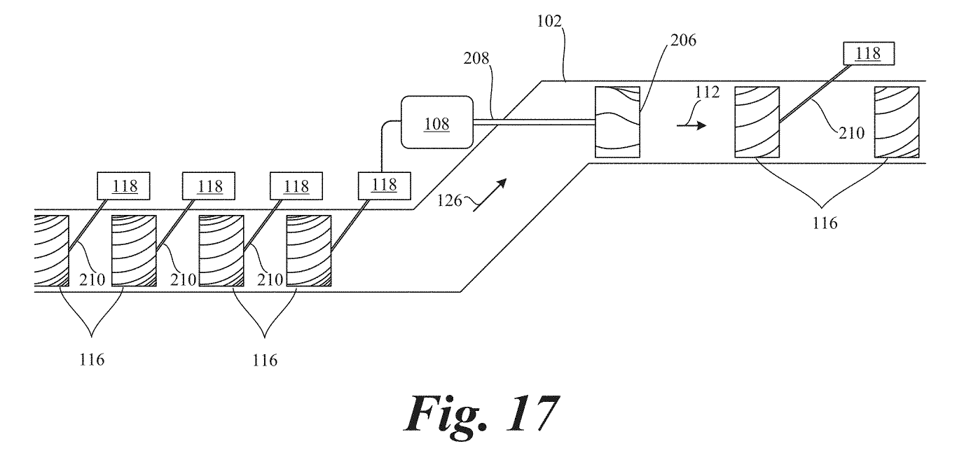

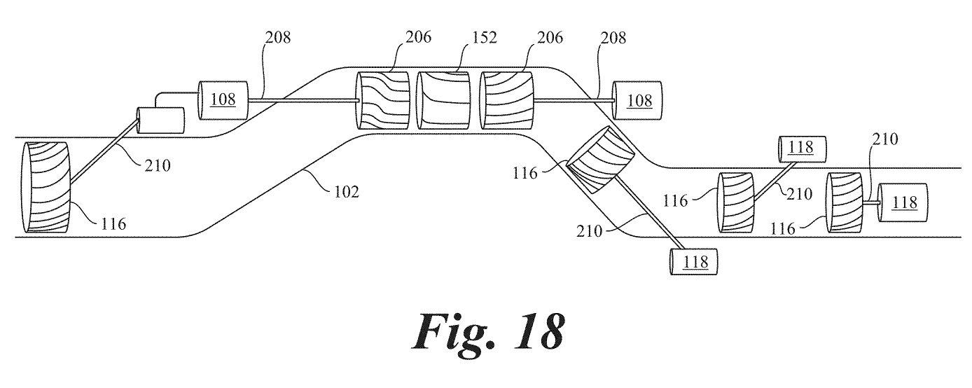

FIGS. 17 & 18 illustrate yet further embodiments of the present invention in which system 100 is a hydraulic system and fluidic streams 112 and 126 are hydraulic fluids. Water is one possible substance that may be used for the fluidic stream 112, 126. A portion of the closed-loop enclosure 102 is depicted in FIG. 17. Impellers 116 suitable for use in hydraulic systems are mounted and operate within the enclosure. Generators 118 connected to the impellors 116 via shafts 210 are located outside the enclosure 102. Similarly, an electric motor 108 is located outside enclosure 102 and is connected by a shaft 208 to power impeller 206. In a manner similar to that described previously for wind powered systems, the power impeller 206 generates fluidic stream 112 which drives generator impellors 116. Eventually, secondary fluidic stream 126 (which is the primary stream 112 less losses incurred during the transit of the closed-loop enclosure 102) is returned to the input side of power impeller 206. Battery 124, controller 132 and switches 134 have been omitted for purposes of clarity, however it is understood that the system in FIG. 17 operates in a manner similar to other embodiments described herein. By way of example, the system 100 in FIG. 17 could be designed on a large scale, in which, for example, the motor is rated 3 kW and the generator(s) 114 are each rated 5 kW. These capacities are for illustration purposes only and are not to be considered a limitation to the capacity of system 100. FIG. 18 illustrates how flow straighteners 152 may be utilized in a hydraulic system, in addition to multiple power impellers 206 and motors 108.

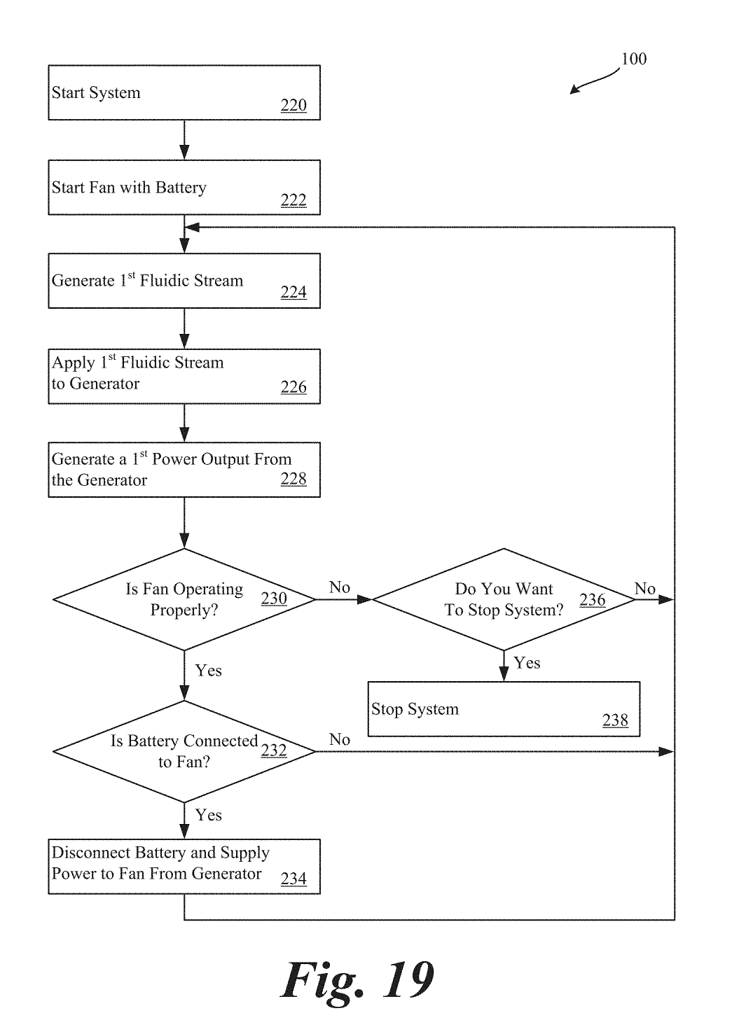

FIG. 19 depicts a flowchart for a method of generating power in a closed loop system in accordance with an embodiment of the present invention. The system 100 is started at step 220. At step 222 the fan is started with a battery or other power supply. At step 224 the running fan generates a first fluidic stream. The fluidic stream is applied to a generator at step 226, which generates a first power output at step 228. At step 230, the operating condition of the fan is verified. If the fan is not operating properly, the operator may elect to stop the system at step 236, and stop the system at step 238. If the operator elects to keep the system operating at step 236, then the system returns to step 224 and continues to generate the first fluidic stream.

At step 230, if the fan is operating properly, the system checks to confirm the battery is still connected to the fan at step 232. If the battery is not connected, the system returns to step 224 and continues to generate the first fluidic stream. If at step 232 the system determines the battery is connected to the fan, the battery is disconnected and power from the generator is supplied to the fan at step 234 and the system returns to step 224 and continues to generate the first fluidic stream.

This patent application describes one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

While the preferred embodiment of the invention has been illustrated and described, as noted above, many changes can be made without departing from the spirit and scope of the invention. For example, the enclosure may have a substantially circular, oval, square or rectangular cross section. The generators may be of the AC, DC or a combination thereof. The fluidic stream may operate as a gas or liquid. Accordingly, the scope of the invention is not limited by the disclosure of the preferred and alternative embodiments. Instead, the invention should be determined entirely by reference to the claims that follow.

What is claimed is:

1. A partial closed-loop fluidic power generator comprising:
an enclosure having a first end and an opposite second end;
a fluidic power supply located at least partially inside the enclosure tunnel, wherein the fluidic power supply generates a fluidic stream based on input from an external supply;
at least two fluidic power generators fluidic power generators located at least partially inside the enclosure in downstream communication with the fluidic power supply, the fluidic power generators generating power from the fluidic stream, and wherein the fluidic power generator comprises a squirrel-cage configuration; and,
at least one honeycomb flow straightener disposed between the at least two fluidic power generators.

2. The partial closed-loop fluidic power generator of claim 1, wherein the first end of the enclosure is coupled to the second end of the enclosure and forms a closed loop.

3. The partial closed-loop fluidic power generator of claim 2, wherein the fluidic power generator is coupled to the fluidic power supply and supplies at least a portion of the power from the fluidic stream to the fluidic power supply.

4. The partial closed-loop fluidic power generator of claim 2 wherein the fluidic power generator is coupled to deliver at least a portion of the fluidic stream to the fluidic power supply.

5. (canceled)

6. (canceled)

7. (canceled)

8. (canceled)

9. (canceled)

10. (canceled)
